(19) United States
(12) Patent Application Publication
(10) Pub. No.: US 2011/0185522 A1
(43) Pub. Date: Aug. 4, 2011

(54) ICE ERADICATOR WITH DEICING FLUID DISPENSER

(76) Inventor: Lawrence B. Parks, Roy, UT (US)

(21) Appl. No.: 12/618,720

(22) Filed: Nov. 14, 2009

(51) Int. Cl. B60S 3/04

(52) U.S. Cl. 15/111

(57) ABSTRACT

A hand tool adopted to remove ice, snow, sleet, frost and the like from the exterior surfaces of a vehicle, including the windows of automobiles. The ice scrapper comprises a rearward grip, a handle, a brush, a squeegee, and a canister containing deicing fluid which is mechanically or electronically operated to disperse deicing fluid onto the window of an automobile to facilitate more efficient removal of crystalline precipitation and condensate.

### BACKGROUND OF THE INVENTION

1. Field of the Invention

The present invention relates generally to the field of personal hand tools. More specifically, the present invention relates to hand tools useful in removing snow, frost, sleet and ice from window glass.

2. Description of the Related Art

In colder climates, automobiles not stored in enclosed garages accumulate snow, ice and frost on the windows and exterior surfaces after intemperate weather, particularly after sitting for periods of several hours or more in crystalline water ice precipitation such as snow, hail, or sleet. Snow, ice, frost and sleet which accumulate on automobiles' exterior surfaces must be removed in whole or part before drivers and passengers can see through the automobiles' windows and operate the vehicles safely.

A variety of hand-tools exist, such as that described in U.S. patent application Ser. No. 11/623,867 (Tucker et al), for removing snow, ice, frost and the like from the windows and exterior surfaces. Most of these tools rely on pressure, and forward-backward motion, manually applied by a human operator to a scrapper-blade in contact with the vehicle to remove the precipitate from the windows.

Certain operators find that it is difficult to apply sufficient pressure to the scrapper to remove the precipitate. Others operators find that they lack the reach to apply the tool over all the target surfaces of the vehicle. Other operators find that certain types of ice and frost cannot be easily eradicated from the exterior surfaces with pressure and scrapping alone.

### SUMMARY

From the foregoing discussion, it should be apparent that a need exists for a means of eradicating crystalline water ice precipitate from the exterior of automobiles. Beneficially, such a means would provide a method and apparatus involving deicing agents, such as ethylene glycol or propolyene glycol, which do not rely strictly on the force applied by human operators to deice surfaces.

The present invention has been developed in response to the present state of the art, and in particular, in response to the problems and needs in the art that have not yet been fully solved by currently available inventions. Accordingly, the present invention has been developed to provide a means of eradicating ice, sleet, snow, frost and condensate from the exterior surfaces of an automobile that overcomes many or all of the above-discussed shortcomings in the art.

It is an object of the present invention to provide a tool for removing ice from an exterior surface of an automobile, which tool comprises, in certain embodiments, a rigid handle, a squeegee fabricated from a flexible elastomer material, the squeegee mounted to a bracket such that the squeegee's leading edge is fixed in a direction perpendicular to the axis of the handle, the bracket mounted on a forward end of the handle; a brush mounted to the tool with flexible bristles; and a fluid canister mounted within the handle for retaining deicing fluid, accessible from a hollow opening in the rearward end of the handle.

The tool may also additionally comprise a twist-off cap affixed to the rearward end of the handle covering the hollow opening; hollow tubing connected between the fluid canister and a nozzle mounted on the forward end of the handle; and a rearward grip surrounding the exterior surface of the rearward end of the handle;

The tool may further comprise a fluid pump mounted to the handle that is activated by hand. The fluid pump may be configured to disperse deicing fluid from the nozzle by transferring deicing fluid from the canister to the nozzle.

The canister incorporated into the too may be mounted adjacent to the handle instead of within the handle, and the tool may further comprise a scraper in place of the squeegee, the scrapper having teeth for breaking ice.

The tool may additionally, or alternatively, comprise a pistol grip affixed to the rearward end of the handle; and a fluid pump mounted to the handle that is activated by a trigger pivotally mounted to the handle forward of the pistol grip. The fluid pump may be configured to disperse deicing fluid from a nozzle mounted on the forward end of the handle by transferring deicing fluid from the canister to the nozzle.

The tool may further comprise hollow tubing connected between the fluid pump and the forward end of the handle. The canister may be mounted adjacent to the handle rather than within the handle.

The tool may further comprise a scrapper in place of the squeegee, the scraper having teeth for breaking ice. The squeegee may be mounted to a bracket such that the squeegee's leading edge is fixed in a direction perpendicular to the axis of the handle, the bracket mounted on a forward end of the handle.

The fluid pump may be electronically activated by an electrical switch, and the tool may further comprise one or more batteries housed within the handle and conductively connected to the fluid pump.

The pistol grip may be telescopically connected to the rearward end of the handle, such that the pistol grip may be extended and retracted from the rearward end of the handle. The pistol grip may be foldably connected to the rearward end of the handle, such that the pistol grip may be folded forward against the handle and folded back to extend away from the rearward end of the handle.

The tool may further comprise a fluid canister mounted to the handle for retaining deicing fluid and pressurized air, the fluid canister slidably movable along the axis of the handle; as well as a pressure release valve mounted on the fluid canister; and, in some embodiments, a pressurization pump mounted to the handle for compressing air into the canister.

The trigger may actuate a flow control valve for ejecting a continuous stream of water from the nozzle in various embodiments of the present invention.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 sets forth a top perspective view of one embodiment of an ice eradicator in accordance with the present invention;

FIG. 2 sets forth a top perspective view of a second embodiment of an ice eradicator in accordance with the present invention;

FIG. 3 sets forth a top perspective view of a third embodiment of an ice eradicator in accordance with the present invention;

FIG. 4 sets forth a top perspective view of a fourth embodiment of an ice eradicator in accordance with the present invention;

FIG. 5 sets forth a top perspective view of a fifth embodiment of an ice eradicator in accordance with the present invention; and

FIG. 6 sets forth a top perspective view of a sixth embodiment of an ice eradicator in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

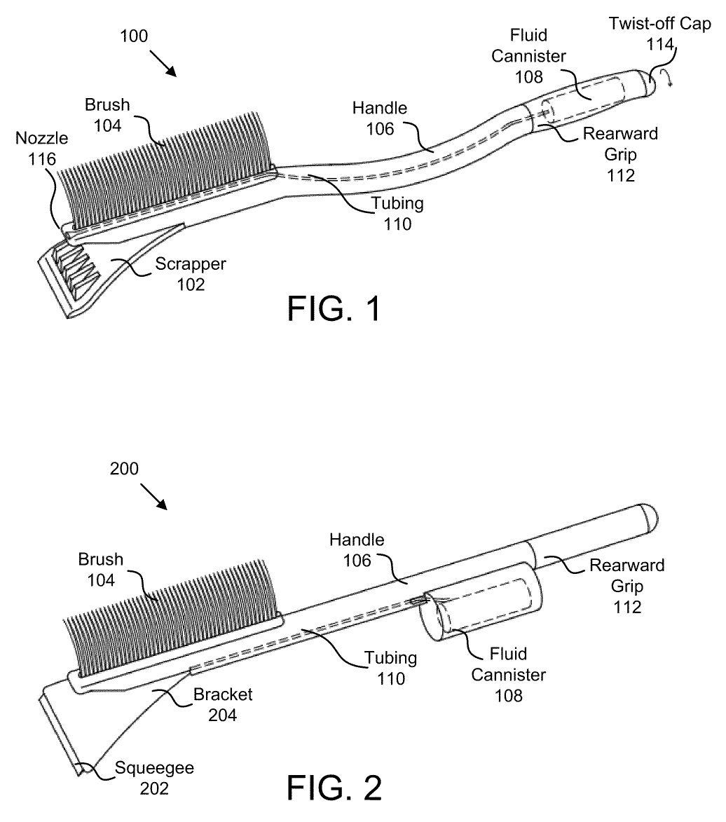

FIG. 1 sets forth a top perspective view of one embodiment of an ice eradicator 100 in accordance with the present invention. The ice eradicator 100 comprises, in this embodiment, a scraper 102, a brush 104, a handle 106, a fluid canister 108, tubing 110, a rearward grip 112, a twist-off cap 114, and a nozzle 116.

The scraper 102 comprises a blade mechanically adapted to scrap ice, snow, sleet and frost from glass, and is well-known to those of skill in the industry. The scraper 102, in various embodiments, may comprise a plastic blade or metal blade. The scraper 102 comprises a generally flat blade which may be curved in some embodiments to trace curved surfaces, such as curved glass surfaces of automobiles.

The brush 104 comprises bristles, wire, or other filaments for removing snow from the exterior surfaces of vehicles, and is well-known in the industry.

The handle 106 comprises a rigid stick-shaped object meant to be held and used ergonomically by human hands. The handle 106 may be tubular. The handle 106 may be formed from one or more of plastic, rubber, wood, metal, glass or any other inflexible or semi-flexible material to which other object may be mounted or affixed with adhesives, screws, nails, tape and the like. Because the handle 106 is meant to be used economically, it may be shaped in off-straight shapes as shown in FIG. 1.

The fluid canister 108, in the shown embodiment, comprises a container or reservoir for holding deicing fluid. The fluid canister 108 may comprise a container of any shape, including cylindrical, round, bottle-shaped, spherical, and the like. The fluid canister 108 may comprise metal, plastic, or organic components, and may be designed to withstand a predetermined amount of pressure.

The deicing fluid used by the ice eradicator 100 may comprise any chemical well-known to those of skill in the art, including ethylene glycol, propylene glycol, saline, and the like.

In various embodiments, the deicing fluid is dispensed from the ice eradicator 100 by activating an electrical or mechanical switch (not shown) on the handle 106, which disperses the deicing fluid pneumatically, electrically or mechanically from the nozzle 116. In some embodiments, the deicing fluid may be dispersed from the ice eradicator 100 by simply squeezing the segment of the handle 106 comprising the fluid canister 108. In some embodiments, both the handle 106 and the canister 108 may comprise flexible materials that can be squeezed by human hands to pressure and disperse the deicing fluid.

The tubing 110 comprises tubing with appropriate chemical resistance to deicing fluid. Tubing is well-known to those of skill in the art. The tubing 110 may comprise polyvinyl chloride (PVC) tubing, silicone rubber tubing, fluorolpoymer tubing, and the like.

The rearward grip 112 comprises, in various embodiments, a sheath or coating over the handle 106 that provides friction against the hand of a human operator, thus reducing the gripping force necessary to operate the ice eradicator 100 and/or reduces the pressure necessary to scrap ice, sleet, snow and/or frost from the exterior surfaces of automobiles. Alternatively, the rearward grip 112 may comprise a deformation in the handle 106 itself rather than a separate component. Such a deformation may change the circumference of the handle 106 irregularly to distribute the surface of the handle 106 more evenly across the hand and fingers of human operator of the ice eradicator 100.

The twist-off cap 114 comprises a threaded screw closure to mechanically seal deicing fluid within the fluid canister 108. The twist-off cap 114, in some embodiments, comprises a metal skirt with threads that screw into threads inside the handle 106. In other embodiments, the rearward end of the handle 106 comprises a skirt with threads over which corresponding threads inside the twist-off cap 114 are screwed.

The present invention may incorporate other types of caps well-known to those of skill in the art, including snap on caps, slide on caps, or doors which open and close over the hollow opening.

The nozzle 116 comprises a mechanical device that controls the direction that the deicing fluid is dispersed when ejected from the ice eradicator 100. The nozzle 116 may be used to control the flow, speed, direction, and shape of the stream of deicing fluid dispersed from the ice eradicator 100. The nozzle 116 well-known to those of skill in the art.

FIG. 2 sets forth a top perspective view of a second embodiment of an ice eradicator 200 in accordance with the present invention. The ice eradicator 200 comprises, in this embodiment, a squeegee 202, a bracket 204, a brush 104, a handle 106, a fluid canister 108, tubing 110, and a rearward grip 112.

The brush 104, the handle 106, the fluid canister 108, the tubing 110, and the rearward grip 112 are all substantially described above in relation to FIG. 1.

The scraper 102 in FIG. 1 is replaced in this embodiment with a squeegee 202. The squeegee 202 is used to remove sleet, ice and frost from the windows and glass, and is well-known to those of skill in the art. The squeegee 202 comprises smooth blade, usually made of rubber. The leading edge of the squeegee 202 in the only segment of the squeegee 202 that comes in contact with the glass or window which the ice eradicator 200 is used to clean.

In various embodiments, the squeegee 202 comprises sponges or foam wipers on its leading edge in place of a rubber blade.

The bracket 204 is a rigid component in the ice eradicator 200 mounted between the squeegee 202 and the forward end of the handle 106.

The scraper 102, the brush 104, the handle 106, the fluid canister 108, the tubing 110, the twist-off cap 114 and the nozzle 116 are all substantially described above in relation to FIGS. 1-2.

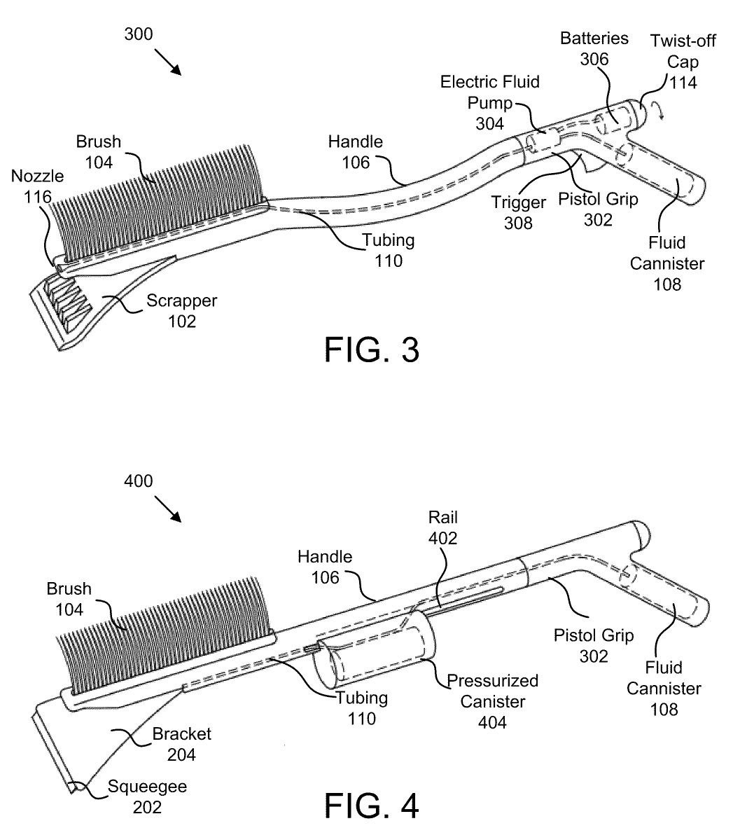

FIG. 3 sets forth a top perspective view of a third embodiment of an ice eradicator 300 in accordance with the present invention. The ice eradicator 300 comprises, in this embodiment, a scraper 102, a brush 104, a handle 106, a fluid canister 108, tubing 110, a pistol grip 302, an electric fluid pump 304, batteries 306, a trigger 308, and a twist-off cap 114, and a nozzle 116.

The scraper 102, the brush 104, the handle 106, the fluid canister 108, the tubing 110, the twist-off cap 114 and the nozzle 116 are all substantially described above in relation to FIGS. 1-2.

The pistol grip 302 comprises a secondary handle protruding laterally from the handle 106 on the rearward end of the handle 106. The pistol grip 302 is shaped such that it orients the hand of the human operator using the ice eradicator 300 in a natural position for comfortably cycling the ice eradicator back and forth across the exterior surface of an automobile.

In various embodiments of the present invention, the pistol grip 302 serves multiple functions, such as housing the canister 108 and/or other mechanical and electrical components necessary to facilitate the ejection of the deicing fluid from the nozzle 116.

The pistol grip 302, in various embodiments, is telescopically connected to the rearward end of the handle 106, such that the pistol grip 302 may be extended from, or collapsed to, or retracted to, the handle 106 along the axis of the handle 106.

In still further embodiments, the pistol grip 302 is hingedly connected to the rearward end of the handle 106 such that the pistol grip 302 can be folded up against the handle 106 to save space when storing the ice eradicator 300. The pistol grip 302 may be connected, in various other embodiments, to the handle 106 using a variety of means well known to those of skill in the art.

The electric pump 304 transfers deicing fluid from the fluid canister 108 to the nozzle 116 through the tubing 110. The electric pump 304 may comprises any fluid pump well-known to those of skill in the art, including a peristaltic pump, a electroosmotic pump, a rotary pump, one or more impellers, and the like.

The electric pump 304 is powered by an internal power supply. The internal power supply in the shown embodiment comprises batteries 306. The batteries 306 are installed and replaced via access provided by, in the shown embodiment, the twist-off cap 114. Batteries 306 are well-known to those of skill in the art.

The present invention may incorporate various simple pumps well-known to those of skill in the art, including positive displacement pumps like those found on common spray bottles.

In other embodiments of the present invention, a second twist-off cap 114 in mounted at the protruding end of the retractable pistol grip 302 to provide access to the canister 108.

The trigger 308 is well-known to those of skill in the art. In the shown embodiment, the trigger 308 is a mechanism that actuates the sequence of mechanical or electrical processes that eject the deicing fluid from the present invention when the trigger 308 is depressed with the index finger of the human operator wielding the ice eradicator 300. The trigger 308 may activate, in various embodiments, a flow control valve mounted to the canister 108.

FIG. 4 sets forth a top perspective view of a fourth embodiment of an ice eradicator 400 in accordance with the present invention. The ice eradicator 400 comprises, in this embodiment, a squeegee 202, a bracket 204, a brush 104, a handle 106, a rail 402, a pressurized canister 404, tubing 110, a pistol grip 302, and a twist-off cap 114.

The squeegee 202, the bracket 204, the brush 104, the handle 106, the fluid canister 108, the tubing 110, the pistol grip 302, and the twist-off cap 114 are all substantially described above in relation to FIGS. 1-3.

The pressurized canister 404 incorporates the canister 108, but is further designed to hold pressurized air forced into the pressurized canister 404 by pumping, or cycling, the pressurized canister 404 back-and-forth along the axis of the handle 106. The pressurized canister 404 imparts pneumatic deicing fluid ejection to the present invention.

In still further embodiments, the pressurized canister 404 is non-slidably mounted to the handle 106 and a separate grip not comprising the pressurized canister 404 mounted below the ice eradicator 400 is pumped to pressurize the pressurized canister 404.

The pumping motion of the pressurized canister 404 pressurizes the pressurized canister 404 using mechanisms and means well-known to those of skill in the art, including one or more pressurization pumps mounted to the handle 106 and/or the pressurized canister 404, and one or more flow control valves mounted to the handle 106 and activated by the trigger 308.

The rail 402 comprises a track built into, or affixed upon, the handle 106 over which the pressurized canister 404 slides when it is pumped by a human operator. The rail 402 guides the pressurized canister 404 as it is cycled back-and-forth.

Various embodiments of the shown embodiment may comprise a trigger 308. Various embodiments of the present invention may incorporate the use of CO2 cartridges in place of a pressurized canister 404. The present invention may also incorporate detachable pre-pressurized canisters in place of the canister 108 and/or the pressurized canister 404, including various types of aerosol canisters.

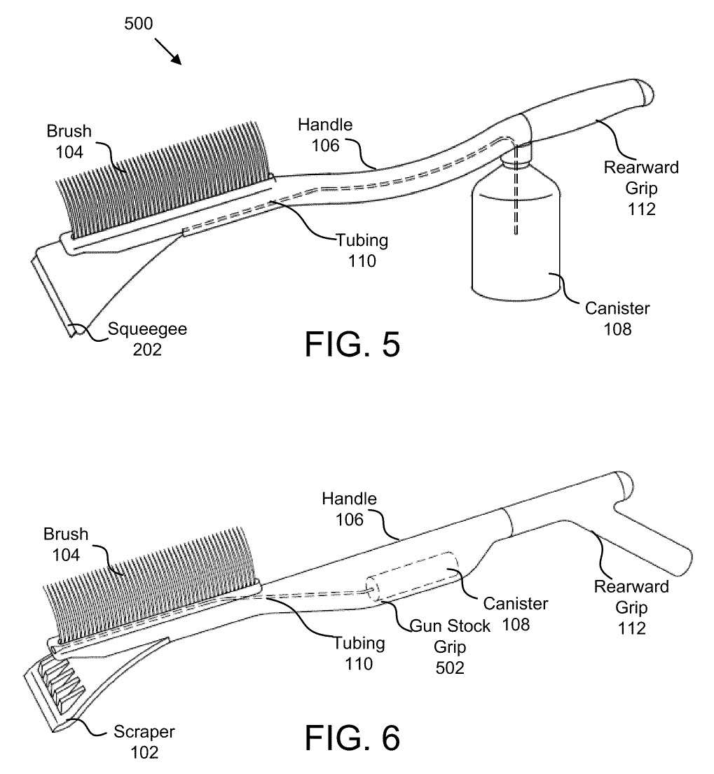

FIG. 5 sets forth a top perspective view of a fourth embodiment of an ice eradicator 500 in accordance with the present invention. The ice eradicator 500 comprises, in this embodiment, a squeegee 202, a brush 104, a handle 106, a fluid canister 108, tubing 110, and a rearward grip 112.

The squeegee 202, the brush 104, the handle 106, the fluid canister 108, the tubing 110, and the rearward grip 112 are all substantially described above in relation to FIGS. 1-4.

The shown embodiment of the ice eradicator 500 is meant to teach that the fluid canister 108 may comprise a container of any shape, connected in any manner to the handle 106. In the shown embodiment, the canister 108 comprises a bottle screwed into a threaded skirt on the handle 106. The canister 108 may be removable, and may clip or snap into place in the handle 106.

FIG. 6 sets forth a top perspective view of a fourth embodiment of an ice eradicator 600 in accordance with the present invention. The ice eradicator 600 comprises, in this embodiment, a scraper 102, a brush 104, a handle 106, a fluid canister 108, tubing 110, and a rearward grip 112.

The scraper 102, the brush 104, the handle 106, the fluid canister 108, the tubing 110, and the rearward grip 112 are all substantially described above in relation to FIGS. 1-5.

The shown embodiment of the ice eradicator 600 is meant to teach that the fluid canister 108 may comprise a container of any shape, connected in any manner to the handle 106. In the shown embodiment, the canister 108 comprises a gun-stock shaped forward grip, in which the canister 108 is housed.

The ice eradicator 600 may also comprise a squeegee 202 in place of the scraper 102. In all embodiments of the present invention, the squeegee 202 may be affixed directly to the handle 106 without the bracket 204.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A tool for removing ice from an exterior surface of an automobile comprising:
a rigid handle;
a squeegee fabricated from a flexible elastomer material, the squeegee mounted to a bracket such that the squeegee's leading edge is fixed in a direction perpendicular to the axis of the handle, the bracket mounted on a forward end of the handle;
a brush mounted to the tool with flexible bristles;
a fluid canister mounted within the handle for retaining deicing fluid, accessible from a hollow opening in the rearward end of the handle;
a twist-off cap affixed to the rearward end of the handle covering the hollow opening;
hollow tubing connected between the fluid canister and a nozzle mounted on the forward end of the handle;
a rearward grip surrounding the exterior surface of the rearward end of the handle;

2. The tool according to claim 1, further comprising a fluid pump mounted to the handle that is activated by hand, the fluid pump configured to disperse deicing fluid from the nozzle by transferring deicing fluid from the canister to the nozzle.

3. The tool according of claim 1, wherein the canister is mounted adjacent to the handle instead of within the handle.

4. The tool according to claim 1, further comprising one or more of sponges, foam wipers, and a scraper in place of the squeegee, the scrapper having teeth for breaking ice.

5. A tool for removing ice from an exterior surface of an automobile comprising:
a rigid handle;
a squeegee fabricated from a flexible elastomer material, the squeegee mounted on a forward end of the handle such that its leading edge is perpendicular to the handle;
a brush mounted to the handle with flexible bristles;
a pistol grip affixed to the rearward end of the handle;
a fluid canister mounted within the handle for retaining deicing fluid, the fluid canister having a capacity of between one and one hundred fluid ounces;
a fluid pump mounted to the handle that is activated by a trigger lever pivotally mounted to the handle forward of the pistol grip, the fluid pump configured to disperse deicing fluid from a nozzle mounted on the forward end of the handle by transferring deicing fluid from the canister to the nozzle;
hollow tubing connected between the fluid pump and the forward end of the handle;

6. The tool according of claim 5, wherein the canister is mounted adjacent to the handle rather than within the handle.

7. The tool according to claim 5, further comprising a scrapper in place of the squeegee, the scraper having teeth for breaking ice.

8. The tool according to claim 5, wherein the squeegee is mounted to a bracket such that the squeegee's leading edge is fixed in a direction perpendicular to the axis of the handle, the bracket mounted on a forward end of the handle.

9. The tool according to claim 5, wherein the fluid pump is electronically activated by an electrical switch, the tool further comprising one or more batteries housed within the handle and conductively connected to the fluid pump.

10. The tool according to claim 5, wherein the pistol grip is telescopically connected to the rearward end of the handle, such that the pistol grip may be extended and retracted from the rearward end of the handle.

11. The tool according to claim 5, wherein the fluid pump comprises a positive displacement pump.

12. The tool according to claim 5, wherein the pistol grip is foldably connected to the rearward end of the handle, such that the pistol grip may be folded forward against the handle and folded back to extend away from the rearward end of the handle.

13. A tool for removing ice from an exterior surface of an automobile comprising:
a rigid handle;
a squeegee fabricated from a flexible elastomer material, the squeegee mounted on a forward end of the handle such that its leading edge is perpendicular to the handle;
a pistol grip affixed to the rearward end of the handle;
a fluid canister mounted to the handle for retaining deicing fluid and pressurized air, the fluid canister slidably movable along the axis of the handle;
a pressure release valve mounted on the fluid canister;
hollow tubing connected between the fluid canister and a nozzle mounted on the forward end of the handle;

14. The tool according to claim 13, further comprising:
a pressurization pump mounted to the handle for compressing air into the canister; and
a trigger actuated flow control valve for ejecting a continuous stream of water from the nozzle.

15. The tool according to claim 13, wherein the fluid canister is pressurized with air by cycling the canister back and forth along the handle.

16. The tool according to claim 13, further comprising one or more pressure chambers mounted to the handle and connected to the canister, the pressure chambers pressurized by sliding the fluid canister along the axis of the handle.

17. The tool according to claim 13, further comprising a scraper in place of the squeegee, the scrapper having teeth for breaking ice.

18. The tool according to claim 13, wherein the squeegee is mounted to a bracket such that the squeegee's leading edge is fixed in a direction perpendicular to the axis of the handle, the bracket mounted on a forward end of the handle.

19. The tool according to claim 13, wherein the pistol grip is telescopically connected to the rearward end of the handle, such that the pistol grip may be extended and retracted from the rearward end of the handle along the axis of the handle.

20. The tool according to claim 13, wherein the pistol grip is foldably connected to the rearward end of the handle, such that the pistol grip may be folded forward against the handle and folded back to extend away from the rearward end of the handle.

21. The tool according to claim 1, claim 5, or claim 13, wherein the canister is removably mounted in place such that it can be detached from the handle, filled, and reattached to the handle.
